(19) United States
(12) Patent Application Publication
(10) Pub. No.: US 2011/0232524 A1
(43) Pub. Date: Sep. 29, 2011

(54) CERAMIC INK FOR MANUFACTURING CERAMIC THICK FILM BY INKJET PRINTING

(75) Inventors: Ji Hoon Kim, Seoul (KR); Young Joon Yoon, Gyeonggi-do (KR); Jong Hee Kim, Seoul (KR); Hyo Tae Kim, Gyeonggi-do (KR); Eun Hae Koo, Daejeon (KR)

(73) Assignee: Korea Institute of Ceramic Engineering and Technology

(21) Appl. No.: 13/121,944

(22) PCT Filed: Oct. 23, 2009
(86) PCT No.: PCT/KR2009/006170

§ 371 Date: Mar. 30, 2011

(30) Foreign Application Priority Data
May 25, 2009 (KR) 10-2009-0045493
Sep. 2, 2009 (KR) 10-2009-0082532

(51) Int. Cl. C09D 11/02

(52) U.S. Cl. 106/31.13

(57) ABSTRACT

The present invention discloses a ceramic ink having an improved refill rate, which enables the manufacture of a ceramic thick film having delicate and improved ceramic properties. To this end, the ceramic ink of the present invention contains a certain amount of a solvent in which ceramic powder is dispersed, and the particles of the ceramic powder have on average a ratio of less than 20% in difference value between the maximum vertical length Dv and the maximum horizontal length Dh with respect to the maximum horizontal length Dh of the cross section of the particle. Also, in case of the presence of a plurality of interior angles at the circumference of the cross section, the maximal angle can be less than 135° among the interior angles. In addition, the solvent can be one or more mixtures selected from the group consisting of a mixture of ethylene glycol monomethyl ether and dipropylene glycol monomethyl ether, a mixture of NN-dimethylformamide and formamide, a mixture of acetonitrile and butanol, a mixture of nitromethane and butanol, and a mixture of water and N,N-dimethylformamide.

### TECHNICAL FIELD

The present invention relates to a ceramic ink for manufacturing a ceramic thick film by inkjet printing and, more particularly, to a ceramic ink having a high and uniform refill rate.

### BACKGROUND ART

Currently, ceramic packaging techniques are used to manufacture passive devices, such as capacitors, resistors, and the like, communication devices, such as front end modules (FEMs), and the like, based on a low temperature co-fired ceramic (LTCC) technique.

In particular, to produce highly integrated ceramic multilayer modules applicable to next generation portable information communication devices which are being continually reduced in size, it is necessary to provide a very large scale integrated system module, which is produced through three-dimensional integration instead of two-dimensional integration in the art. However, the LTCC has a sintering temperature of 900° C., which is lower than the sintering temperature (generally 1500° C.) of typical ceramics but still too high to be joined to heterogeneous materials such as electrodes formed of metal conductors in the module. Moreover, it is difficult to realize a fine circuit of the very large scale integrated system module.

To solve such problems, non-sintering ceramic manufacturing processes have been developed. In particular, inkjet printing has been developed in recent years to manufacture a ceramic thick film. In the inkjet printing, a liquid ink containing a material to be stacked on a substrate is ejected to form a thick film on the substrate and is prepared by dispersing a fine ceramic or metal powder in a suitable solvent. In drop-on-demand (DOD) printing, the prepared ink is received in a cavity composed of a piezoelectric actuator and is compressed to eject ink droplets to a desired position of a predetermined substrate at a constant ejection rate, thereby forming a thick film. The thick film may exhibit physical properties of a ceramic film without sintering at high temperature.

Moreover, since such an inkjet printing process permits formation of a desired pattern in a non-contact manner, this process is suitable to realize shapes related to, for example, electronic circuits, nano-structures, bio-materials, structural materials, and the like. Further, since inkjet printing may allow various shapes to be directly printed in response to digital signals, inkjet printing enables printing of a shape having a size of several dozen micrometers to a few square meters on various substrates such as paper, fabric, metal, and the like. In addition, since inkjet printing permits selective printing at any desired place, it has environmental friendliness through a significant reduction in material costs and provides high investment efficiency through elimination of an exposure process and use of a non-vacuum process.

In particular, since inkjet printing provides a ceramic film without sintering, it is necessary for the prepared ceramic film to be a dense film in order to exhibit good properties, and fabrication of such a dense film depends on a refill rate. Herein, refill rate refers to a percentage of ceramic powder densely stacked in the film when liquid of the ejected ink containing the ceramic powder is evaporated. As the refill rate increases, the film becomes denser. For example, when a composite film is formed by mixing glass and an alumina powder as the conventional LTCC, the refill rate of the alumina powder in the film is merely about 30˜50 percent by volume (vol %). Further, in a manufacturing method based on film casting, the refill rate of the alumina powder in the film has a relatively low value of about 50 vol %. Since these conventional methods require a sintering process, there is no particular problem. However, for inkjet printing which eliminates the sintering process, it is necessary to achieve a higher refill rate than that in these conventional methods.

Further, in inkjet printing, 200 pl (picoliters) or less of ink droplet is generally ejected to a surface of a solid material such as a substrate and spreads over the surface to form an ellipsoidal cap. FIG. 1 shows this phenomenon and is a schematic diagram explaining convection in an ink droplet ejected to the substrate.

Referring to FIG. 1, when a droplet 1 is ejected, a periphery 2 of the droplet 1 defining an interface between the droplet 1 and a substrate 4 is thinner than a center 3 of the droplet 1, so that an ink solvent evaporates earlier at the periphery 2 than at the center 3. Further, as convection in the droplet for compensating for mass loss resulting from the evaporation at the periphery 2, an outward flow (indicated by arrow “A”) occurs in the droplet, so that the ink solvent is moved from the center 3 towards the periphery 2. The ceramic powder dispersed in the ink solvent is crowded at the periphery 2 by the outward flow of the ink solvent, causing a coffee ring phenomenon wherein a large amount of ceramic powder is selectively stacked only at the periphery 2 of the droplet 1 after complete evaporation of the ink solvent. This coffee ring phenomenon causes uneven filling of the ceramic powder in the film.

Further, FIGS. 2 to 5 show dot ceramic patterns formed using several kinds of ceramic ink by general inkjet printing. Specifically, FIG. 2 is an electron micrograph of a dot pattern formed using an alumina (Al₂O₃) ceramic ink, FIG. 3 is a graph of surface roughness of the dot pattern shown in FIG. 2, FIG. 4 is an electron micrograph of a dot pattern formed using a barium titanate (BaTiO₃) ceramic ink, and FIG. 5 is a graph of surface roughness of the dot pattern shown in FIG. 4. Further, FIGS. 6 and 7 show line ceramic patterns formed using an alumina ceramic ink by general inkjet printing. Specifically, FIG. 6 is an electron micrograph of the line pattern and FIG. 7 is a graph of surface roughness of the line pattern shown in FIG. 6.

Referring to FIGS. 2, 4 and 6, it can be seen that the coffee ring pattern is formed by the ejected ink droplet when inkjet printing is performed using the ceramic ink of the alumina or barium titanate powder. Further, as shown in FIGS. 3, 5 and 7, the graphs of the surface roughness having a so-called “rabbit ear” distribution show that the ceramic powder is unevenly distributed. For values of the surface roughness in the graphs, a ratio of peak (P) to valley (V) of less than 1.5 may indicate uniform filling of the ceramic powder. Referring to FIGS. 3, 5 and 7, however, since the ratio of peak (P) to valley (V) is much greater than 1.5 (ratio of P/V is about 10:1) and the coffee ring pattern is formed near the periphery 2, it can be seen that uneven filling of the ceramic powder occurs. Such uneven filling of the ceramic powder disturbs uniform formation of the ceramic pattern in a structure and a circuit, thereby deteriorating properties of devices.

### DISCLOSURE

### Technical Problem

Therefore, the present invention is conceived to solve such problems and an aspect of the present invention is to provide a ceramic ink which has a high and uniform refill rate to enable the manufacture of a dense film through inkjet printing.

### Technical Solution

In accordance with one aspect of the present invention, ceramic ink includes a solvent having a ceramic powder dispersed therein and is printed on a substrate by inkjet printing to form a thick ceramic film, wherein Dᵥ and Dₕ of particles of the ceramic powder averagely satisfy the following Equation 1, and, assuming that a plurality of interior angles is defined along a periphery of a cross-section of each of the particles, the maximum interior angle is less than 135 degrees.

$$\frac{\vert {D}_{h} - {D}_{v} \vert}{{D}_{h}} < 20 \% , \qquad Equation 1$$

where Dᵥ and Dₕ indicate the maximum vertical length and the maximum horizontal length of the cross-section of each of the particles, respectively.

Here, the ceramic powder may have a multi-modal size distribution. For example, the multi-modal size distribution is in the range of 20 nm˜1 μm.

In accordance with another aspect of the present invention, a ceramic ink includes a solvent having a ceramic powder dispersed therein and is printed on a substrate by inkjet printing to form a thick alumina ceramic film, wherein the solvent may be at least one mixture selected from the group consisting of a mixture of ethylene glycol monomethyl ether and dipropylene glycol monomethyl ether, a mixture of N,N-dimethylformamide and formamide, a mixture of acetonitrile and butanol, a mixture of nitromethane and butanol, and a mixture of water and N,N-dimethylformamide.

In accordance with a further aspect of the present invention, a ceramic ink includes a solvent having a ceramic powder dispersed therein and is printed on a substrate by inkjet printing to form a thick alumina ceramic film, wherein the solvent may comprise at least one selected from the group consisting of: a composition of (100−x) vol % of ethylene glycol monomethyl ether+x vol % of dipropylene glycol monomethyl ether; a composition of (100−x) vol % of N,N-dimethylformamide+x vol % of formamide; a composition of (100−x) vol % of acetonitrile+x vol % of butanol; a composition of (100−x) vol % of nitromethane+x vol % of butanol; and a composition of (100−x) vol % water+x vol5 of N,N-dimethylformamide. Here, x is in the range of 0<x≦25, for example, 5≦x≦25. Further, the ceramic powder may be contained in an amount of 1 vol %˜12 vol % with respect to the total amount of ceramic ink.

### Advantageous Effect

According to exemplary embodiments of the invention, a ceramic ink ensures a high and uniform refill rate of a thick film formed by inkjet printing, thereby enabling manufacturing of a thick ceramic film having dense and improved ceramic properties.

### DESCRIPTION OF DRAWINGS

FIG. 1 is a schematic diagram explaining convection in a droplet ejected by general inkjet printing;

FIGS. 2 to 5 show dot ceramic patterns formed using several kinds of ceramic ink by general inkjet printing, in which FIG. 2 is an electron micrograph of a dot pattern formed using an alumina (Al₂O₃) ceramic ink, FIG. 3 is a graph of surface roughness of the dot pattern shown in FIG. 2, FIG. 4 is an electron micrograph of a dot pattern formed using a barium titanate (BaTiO₃) ceramic ink, and FIG. 5 is a graph of surface roughness of the dot pattern shown in FIG. 4;

FIGS. 6 and 7 show line ceramic patterns formed using an alumina ceramic ink by general inkjet printing, in which FIG. 6 is an electron micrograph of the line pattern and FIG. 7 is a graph of surface roughness of the line pattern shown in FIG. 6;

FIGS. 8 and 9 are cross-sectional views of ceramic powder particles;

FIG. 10 is an electron micrograph of a thick film filled with a spherical alumina powder;

FIG. 11 is an electron micrograph of a thick film filled with a non-spherical alumina powder;

FIG. 12 is a schematic diagram explaining convection in a droplet according to a mechanism of an exemplary embodiment of the present invention;

FIGS. 13 to 17 are electron micrographs of a ceramic thick film according to one example of the invention, in which FIG. 13 is a micrograph (at 500× magnification) of a thick film after evaporation of a ceramic ink droplet from a Cu substrate, FIG. 14 is a micrograph (at 20,000× magnification) of an end part C of the ink droplet of FIG. 13, FIG. 15 is a micrograph (at 35,000× magnification) of the end part C of the ink droplet of FIG. 13, FIG. 16 is a micrograph (at 30,000× magnification) of a central part D of the ink droplet of FIG. 13, and FIG. 17 is a micrograph (at 10,000× magnification) of the thick film after evaporation of the ceramic ink droplet from the Cu substrate;

FIGS. 18 to 22 are electron micrographs of a ceramic thick film according to a comparative example, in which FIG. 18 is a micrograph (at 300× magnification) of a thick film after evaporation of a ceramic ink droplet from a Cu substrate, FIG. 19 is a micrograph (at 5,000× magnification) of an end part E of the ink droplet of FIG. 18, FIG. 20 is a micrograph (at 15,000× magnification) of the end part E of the ink droplet of FIG. 18, FIG. 21 is a micrograph (at 15,000× magnification) of a central part F of the ink droplet of FIG. 18, and FIG. 22 is a micrograph (at 10,000× magnification) of the thick film after evaporation of the ceramic ink droplet from the Cu substrate;

FIGS. 23 to 26 show dot and line pattern alumina ceramic films formed using Mixture Solvent 1 in another example of the present invention, in which FIG. 23 is an electron micrograph of the dot pattern, FIG. 24 is a graph of surface roughness of the dot pattern of FIG. 23, FIG. 25 is a CCD image of the line pattern, and FIG. 26 is a graph of surface roughness of the line pattern of FIG. 25;

FIGS. 27 to 30 show dot and line pattern barium titanate ceramic films formed Mixture Solvent 1 according to a further example of the present invention, in which FIG. 27 is an electron micrograph of the dot pattern, FIG. 28 is a graph of surface roughness of the dot pattern of FIG. 27, FIG. 29 is a CCD image of the line pattern, and FIG. 30 is a graph of surface roughness of the line pattern of FIG. 29;

FIGS. 31 to 34 show dot and line pattern alumina ceramic films formed Mixture Solvent 2 according to yet another example of the present invention, in which FIG. 31 is an electron micrograph of the dot pattern, FIG. 32 is a graph of surface roughness of the dot pattern of FIG. 31, FIG. 33 is a CCD image of the line pattern, and FIG. 34 is a graph of surface roughness of the line pattern of FIG. 33; and

FIGS. 35 to 38 show dot and line pattern barium titanate ceramic films formed Mixture Solvent 2 of yet another example of the present invention, in which FIG. 35 is an electron micrograph of the dot pattern, FIG. 36 is a graph of surface roughness of the dot pattern of FIG. 35, FIG. 37 is a CCD image of the line pattern, and FIG. 38 is a graph of surface roughness of the line pattern of FIG. 33.

### BEST MODE

As such, in the non-sintering inkjet manufacturing process, when an ink droplet having a ceramic powder dispersed in a solvent is ejected to a substrate, the liquid component of the ink is evaporated from an interface between the substrate and the ink droplet, so that the ceramic powder of the ink droplet is stacked on the substrate. In other words, as the droplet ejected to the substrate is evaporated from the surface of the substrate, a difference in surface tension occurs due to a temperature gradient in the ink droplet, causing a fine flow of a fluid in the droplet. The flow acts as a driving force that causes the ceramic powder to move and be stacked in a predetermined direction in the droplet.

Accordingly, the inventors found that movement and stacked features of the ceramic powder particles vary according to the shape and size distribution of the ceramic powder particles in the droplet during inkjet printing, and that when the powder particles have a spherical shape, fiction between the particles moving in the droplet is minimized, thereby providing more effective stacking of the powder particles.

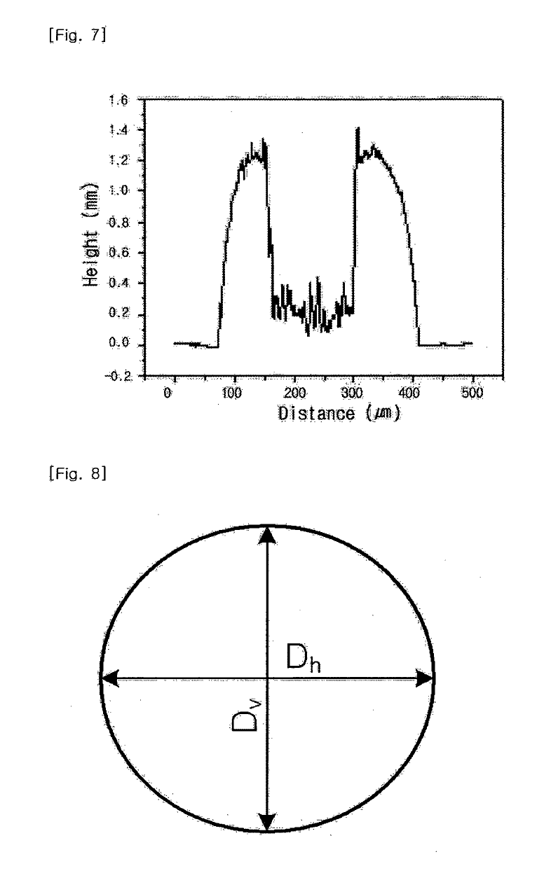

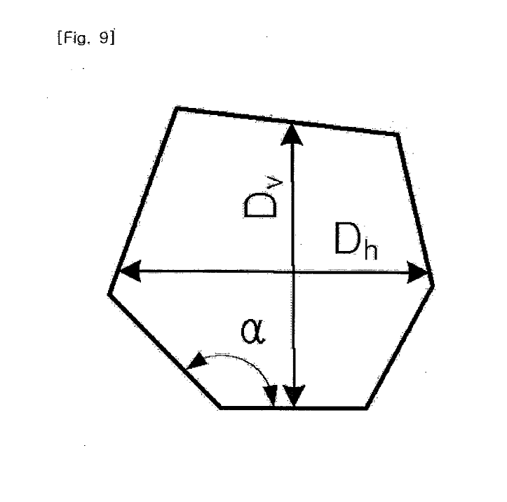

Herein, according to exemplary embodiments of the invention, the term “spherical” may be defined as in FIGS. 8 and 9. Specifically, although an ideally spherical shape may be defined as a sphere having a constant diameter as shown in FIG. 8, the possibility of forming such an ideal sphere is very low in practice, and most actual powder particles may have a polygonal shape, which has a plurality of interior angles (α) defined along a periphery of each of the particles, as shown in FIG. 9. Therefore, in the embodiments of the invention, the shape of the ceramic powder particles may be defined as a spherical shape when a relationship between Dᵥ and Dₕ of particles of the ceramic powder averagely satisfy the following Equation 1 and the maximum interior angle (α) satisfies Equation 2, assuming that a plurality of interior angle (α) is defined along the periphery of a cross-section of each of the particles.

<Equation 1>

$$\frac{\vert {D}_{h} - {D}_{v} \vert}{{D}_{h}} < 20 \% ,$$

wherein Dᵥ and Dₕ indicate the maximum vertical length and the maximum horizontal length of the cross-section of each of the particles, respectively.

α<135 degrees <Equation 2>

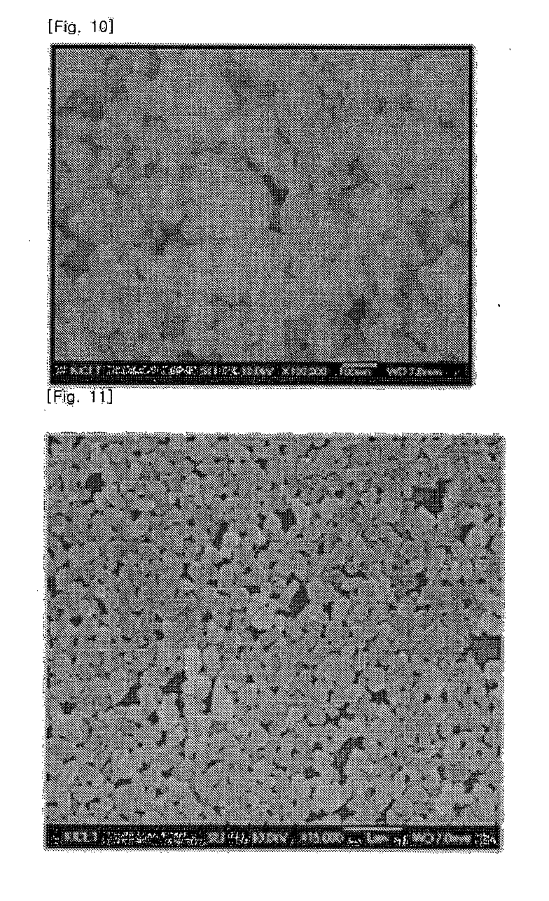

The shape of the powder particles is determined based on such a shape standard through observation of a cross-section or surface of a prepared ceramic thick film using a scanning electron microscope (SEM). FIG. 10 is an electron micrograph of a thick film filled with a spherical alumina powder, and FIG. 11 is an electron micrograph of a thick film filled with a non-spherical alumina powder.

Further, according to an exemplary embodiment, the ceramic powder may have a multi-modal size distribution rather than a single modal size distribution to achieve optimal high-density filling of the powder particles. Accordingly, a space between stacked powder particles having relatively large sizes can be filled with powder particles having relatively small sizes, thereby providing an improved refill rate. For example, the size distribution may be in the range of 20 nm˜1 μm.

In one example of the invention, it was ascertained that when an ink was prepared using a spherical ceramic powder having the multi-modal size distribution and was printed to form a thick film through inkjet printing, the refill rate of the powder in the thick film was 16% or more higher than that of a thick film prepared using a non-spherical ceramic powder.

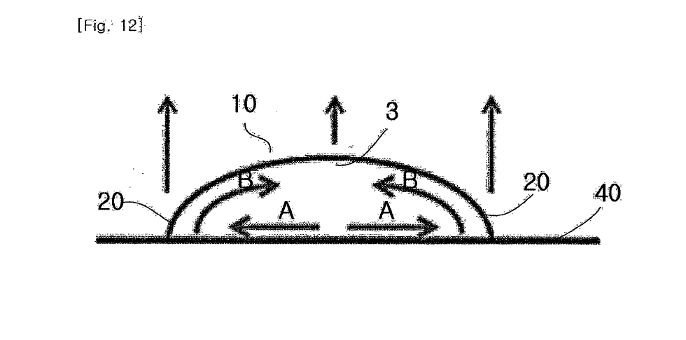

In another exemplary embodiment of the invention, a mixture solvent having a suitable combination of boiling point (BP) and surface tension was prepared and used to prepare an ink droplet having a ceramic powder dispersed in the solvent. When the ink droplet is ejected by inkjet printing, it is possible to prevent formation of the coffee ring pattern and to achieve uniform filling of the ceramic powder. FIG. 12 is a diagram explaining a mechanism of this embodiment.

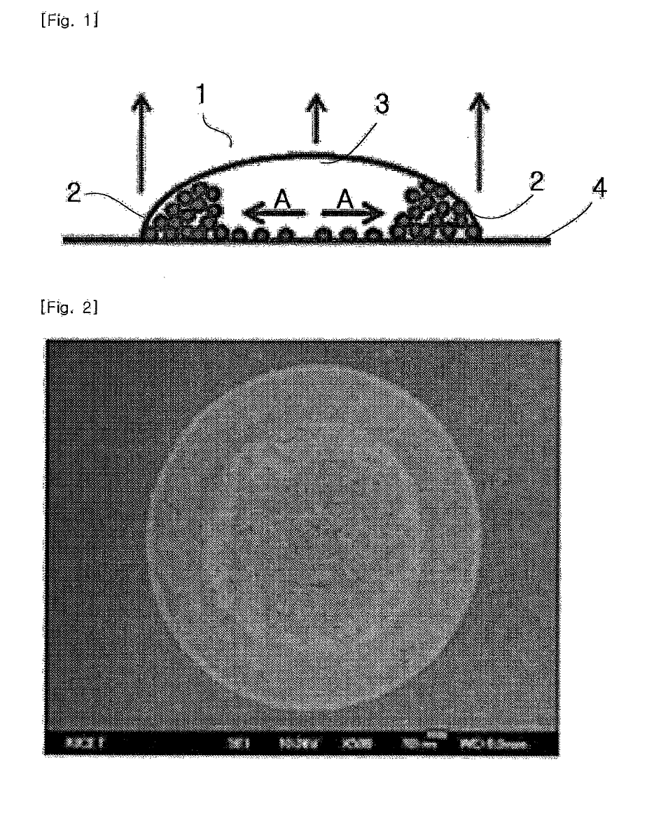

Referring to FIG. 12, in a droplet 10 ejected by inkjet printing, an outward flow (indicated by arrow “A”) occurs due to convection in the droplet 10, as described with reference to FIG. 1, so that the ceramic powder is crowded at the periphery 2, thereby causing uneven filling of the ceramic powder, such as the coffee ring phenomenon or the like. As shown in FIG. 12, however, such an outward flow A may be compensated for by an inward flow (indicated by arrow “B”) generated in this embodiment. Here, such an inward flow B may be generated by driving forces of a flow caused by a composition gradient and/or a flow caused by a surface tension gradient.

First, the flow caused by the composition gradient may be provided by a mixture solvent, which comprises a main solvent and a drying controller having a higher boiling point than the main solvent. In the ejected semispherical droplet 10, since a periphery 20 of the droplet 1 has a shorter distance for heat transfer than a center 30 of the droplet 1, the periphery 20 undergoes a greater amount of heat transfer from a lower portion of the droplet to the surface of the droplet than the center 30. As such, the droplet 1 has a higher surface temperature at the periphery 20 than at the center 30. Here, since the drying controller has a higher boiling point than the main solvent, the main solvent evaporates from the periphery 20 earlier than other portions of the droplet, so that the concentration of the drying controller relatively increases at the periphery 20, thereby generating a concentration gradient from the center 20 to the periphery 30. The concentration gradient results in the inward flow B of the drying controller from the periphery 30 towards the center 20.

Further, the flow caused by the surface tension gradient may be provided by allowing the drying controller of the mixture solvent to have lower surface tension than the main solvent of the mixture solvent. As a result, the surface tension gradient is generated between the periphery 30 and the center 20 of the droplet due to an increase in the concentration of the drying controller, which has a relatively low surface tension, at the periphery 30, thereby causing the inward flow B of the drying controller from the periphery 30 towards the center 20. The inward flow caused by the surface tension gradient promotes the inward flow caused by the composition gradient, thereby providing optimal effects. The inward flow generated by the driving forces of the flow caused by the composition gradient and/or the flow caused by the surface tension gradient compensates for the outward flow, thereby enabling uniform filling of the ceramic powder in the film.

As such, in the embodiment of the invention, the mixture solvent of the ceramic ink for a ceramic thick film by inkjet printing includes the main solvent and the drying controller. For example, the mixture solvent may be at least one mixture selected from the group consisting of a mixture of ethylene glycol monomethyl ether and dipropylene glycol monomethyl ether, a mixture of N,N-dimethylformamide and formamide, a mixture of acetonitrile and butanol, a mixture of nitromethane and butanol, and a mixture of water and N,N-dimethylformamide, as in Mixture Solvents 1 to 5 described hereinafter. Here, the amount of drying controller, that is, x vol %, may be in the range of x≦25, for example, 5≦x≦25.

Mixture Solvent 1

(100−x) vol % of ethylene glycol monomethyl ether+x vol % of dipropylene glycol monomethyl ether

Mixture Solvent 2

(100−x) vol % of N,N-dimethylformamide+x vol % of formamide

Mixture Solvent 3

(100−x) vol % of acetonitrile+x vol % of butanol

Mixture Solvent 4

(100−x) vol % of nitromethane+x vol % of butanol

Mixture Solvent 5

(100−x) vol % water+x vol5 of N,N-dimethylformamide

Further, since an increase in the amount of ceramic powder dispersed in the mixture solvent results in an increase in resistance to the flow in the droplet, the ceramic powder may be contained in an amount of 1˜12 vol % with respect to the total amount of ceramic ink prepared by dispersing the ceramic powder in the mixture solvent. Further, the compositions of Mixture Solvents 1 to 5 are selected to provide different boiling points and surface tensions to the components of each of the mixture solvents, as shown in Table 1.

TABLE 1

| | | | Surface |
|---|---|---|---|
| Mixture | | Boiling | tension |
| Solvent | Solvent | point (° C.) | (dyne/cm) |
| 1 | ethylene glycol monomethyl ether | 120 | 42.8 |
| | dipropylene glycol monomethyl ether | 180 | 28.4 |
| 2 | N,N-dimethylformamide | 120 | 36.7 |
| | formamide | 210 | 52.8 |
| 3 | acetonitrile | 82 | 29.29 |
| | butanol | 125 | 24.2 |
| 4 | nitromethane | 100 | 36.88 |
| | butanol | 125 | 24.2 |
| 5 | water | 100 | 78 |
| | N,N-dimethylformamide | 153 | 36 |

Referring to Table 1, since the main solvent of each of Mixture Solvents 1 and 3 to 5 has a lower boiling point and a higher surface tension than the drying controller, the inward flow is generated by two kinds of driving forces resulting from the composition gradient and the surface tension gradient, thereby compensating for the outward flow. For Mixture Solvent 2, since the main solvent has a significantly lower boiling point and a lower surface tension than the drying controller, a sufficient inward flow is generated mainly by the driving force resulting from the composition gradient, thereby compensating for the outward flow.

Next, examples of the present invention will be described with reference to the accompanying drawings. However, it should be understood that these examples are provided for thorough understanding of the invention and are not intended to limit the scope of the invention.

### Example 1

### Preparation and Analysis of Ceramic Ink Comprising Spherical Ceramic Powder Having Multi-Modal Size Distribution

In this example, a ceramic ink was prepared by dispersing 8 vol % of a spherical alumina powder (Al₂O₃, ASFP-20 obtained from Denka Co., Ltd., JP) having a size distribution of 20 nm˜1 μm in DMF (N,N-dimethylformamide, boiling point: 153° C., surface tension: 40.4 dyne/cm) as an ink solvent, and droplets of the ink were then ejected to a 1.5 mm copper substrate at 50° C. to form a thick film on the substrate by typical drop-on-demand (DOD) inkjet printing. The ink droplets had a volume of 150˜180 μl (pico liter) and was ejected at an ejection frequency of 600˜1,000 Hz and at a pitch of 50˜100 μm between the ink droplets. The printed thick film has lines separated from each other by a distance of 25˜50 μm and had a printed area of 11×11 mm². Then, distribution of the powder on the prepared thick film was observed using SEM after evaporation of the ink and the refill rate of the thick film was calculated by Equation 3:

Refill rate=W_{film weight}/ρ_{density}×1/(Aₐᵣₑₐ×t_{film thickness})×100,

where W indicates the weight of the ceramic (that is, alumina) thick film, ρ indicates the theoretical density of ceramic (for alumina, 3.97 g/cc), A indicates the printed area, and t indicates the thickness of the thick film.

As a comparative example with respect to Example 1, a non-spherical alumina powder having a single size distribution of a 0.3 μm particle size was used to form a thick film by the same method as in Example 1, and the refill rate was calculated according to Equation 3.

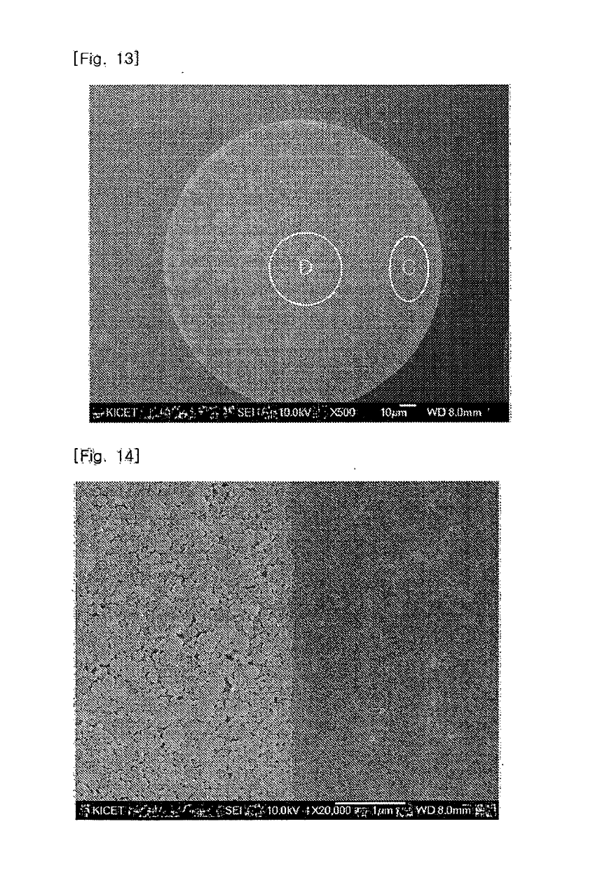

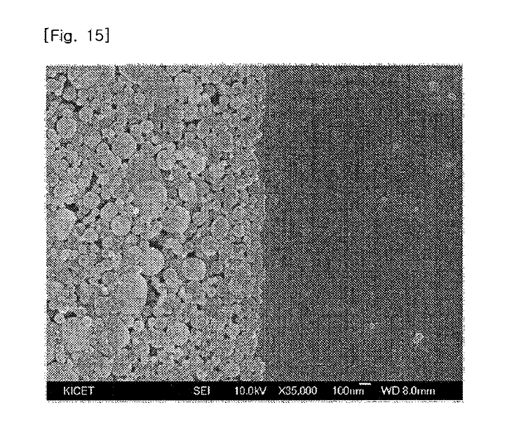

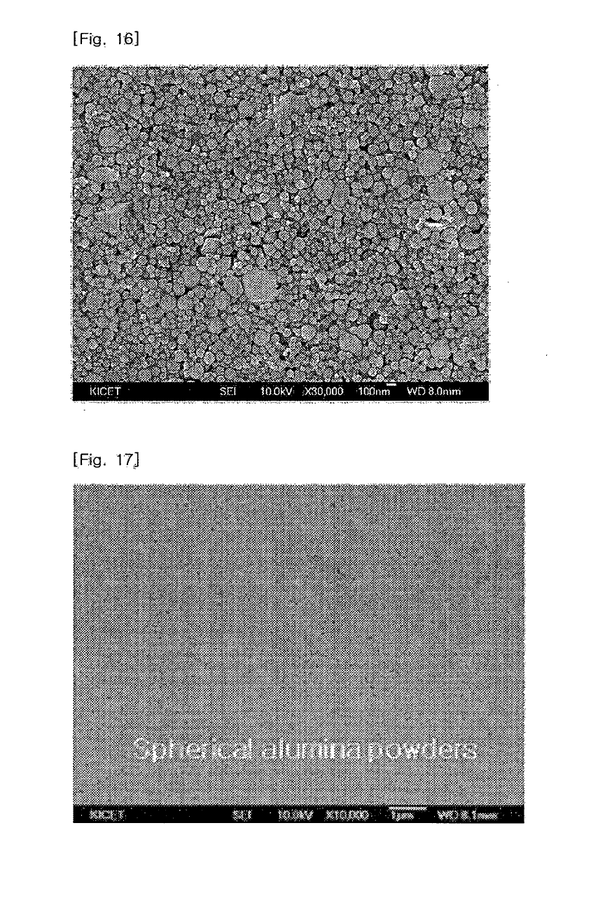

FIGS. 13 to 17 are electron micrographs of a ceramic thick film according to this example. Specifically, FIG. 13 is a micrograph (at 500× magnification) of the thick film after evaporation of the ceramic ink droplet from the Cu substrate, FIGS. 14 and 15 are micrographs (at 20,000× magnification and at 35,000× magnification, respectively) of an end part C of the ink droplet of FIG. 13, FIG. 16 is a micrograph (at 30,000× magnification) of a central part D of the ink droplet of FIG. 13, and FIG. 17 is a micrograph (at 10,000× magnification) of the thick film after evaporation of the ink droplet from the Cu substrate. Referring to these micrographs, it can be seen that the spherical powder was densely stacked.

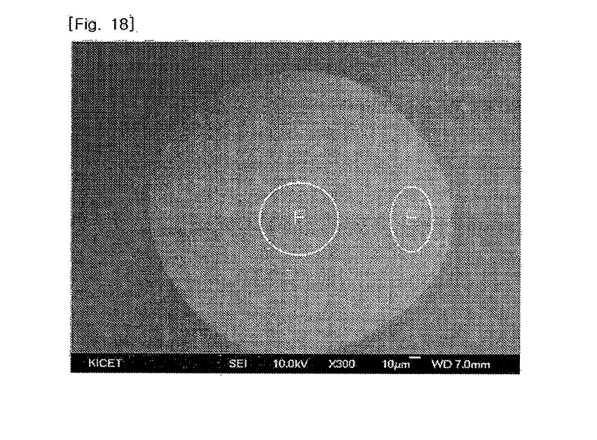

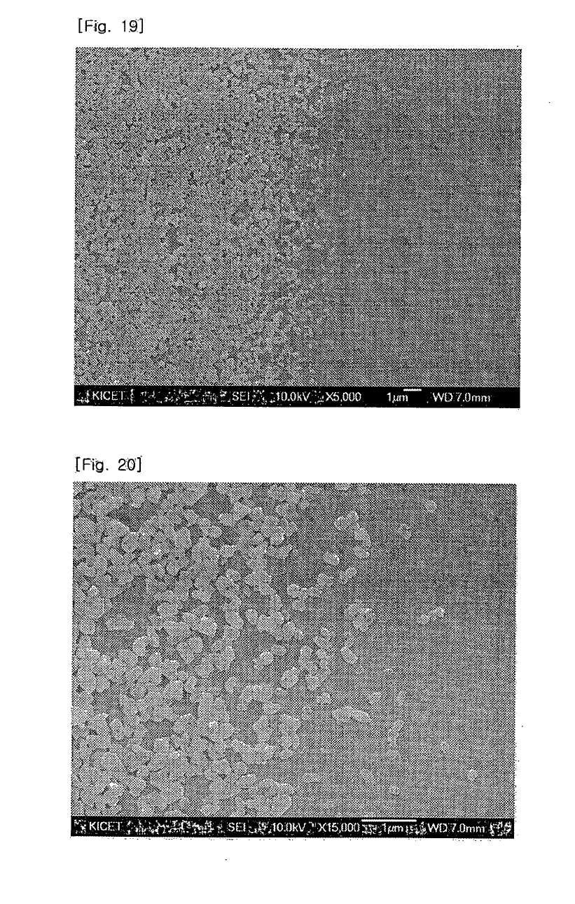

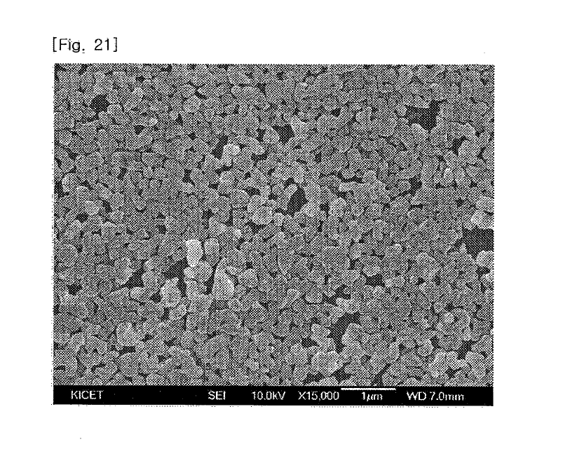

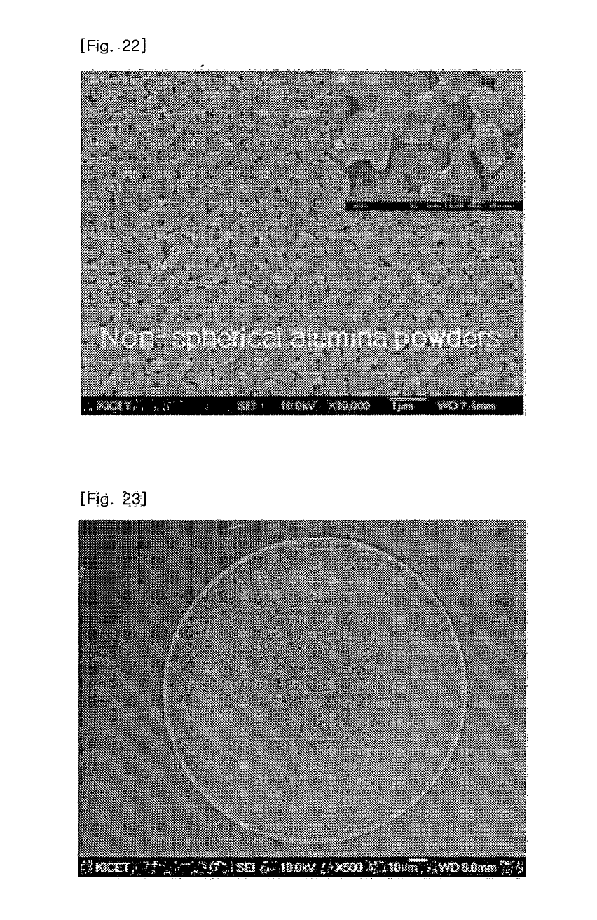

Further, FIGS. 18 to 22 are electron micrographs of a ceramic thick film according to a comparative example. Specifically, FIG. 18 is a micrograph (at 300× magnification) of a thick film after evaporation of the ceramic ink droplet from the Cu substrate, FIGS. 19 and 20 are micrographs (at 5,000× magnification and at 15,000× magnification, respectively) of an end part E of the ink droplet of FIG. 18, FIG. 21 is a micrograph (at 15,000× magnification) of a central part F of the ink droplet of FIG. 18, and FIG. 22 is a micrograph (at 10,000× magnification) of the thick film after evaporation of the ceramic ink droplet from the Cu substrate. Referring to these micrographs, it can be seen that the non-spherical powder was not densely stacked, and was instead sparsely stacked on the film after evaporation of the ink, unlike the spherical powder.

Table 2 show refill rates of the thick films of Example 1 and the comparative example, which were prepared using the spherical powder and the non-spherical powder, respectively. Referring to Table 2, it can be seen that the spherical powder provided an about 16% higher refill rate than the non-spherical powder.

TABLE 2

| | Film thickness | Printed area | Film weight | Refill rate |
|---|---|---|---|---|
| | (μm) | (mm²) | (g) | (%) |
| Comparative | 5.12 | 149.32 × 8 | 0.00875 | 57.6 |
| Example | | | | |
| Example | 5.23 | 138.53 × 4 | 0.0078 | 68.5 |

### Example 2

### Preparation and Analysis of Ceramic Ink Comprising Ceramic Powder Dispersed in Mixture Solvent

In this example, a ceramic ink was prepared by dispersing alumina (Al₂O₃) and barium titanate (BaTiO₃) ceramic powders in Mixture Solvent 1 (75 vol % of ethylene glycol monomethyl ether+25 vol % of dipropylene glycol monomethyl ether) and in Mixture Solvent 2 (75 vol % of N,N-dimethylformamide+25 vol % of formamide), respectively, and was then ejected by inkjet printing to form a ceramic thick film having a dot pattern and a line pattern ceramic thick film. Then, fine structure and surface roughness of these thick films were observed.

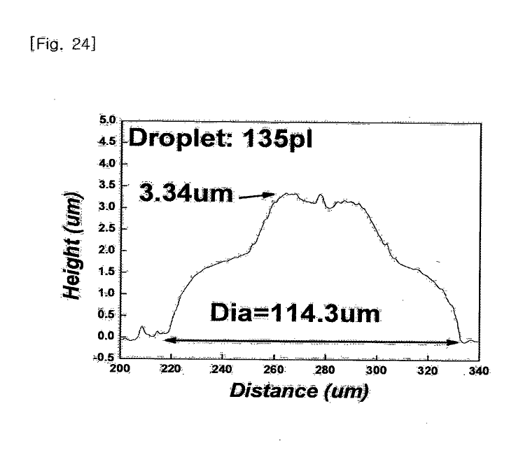

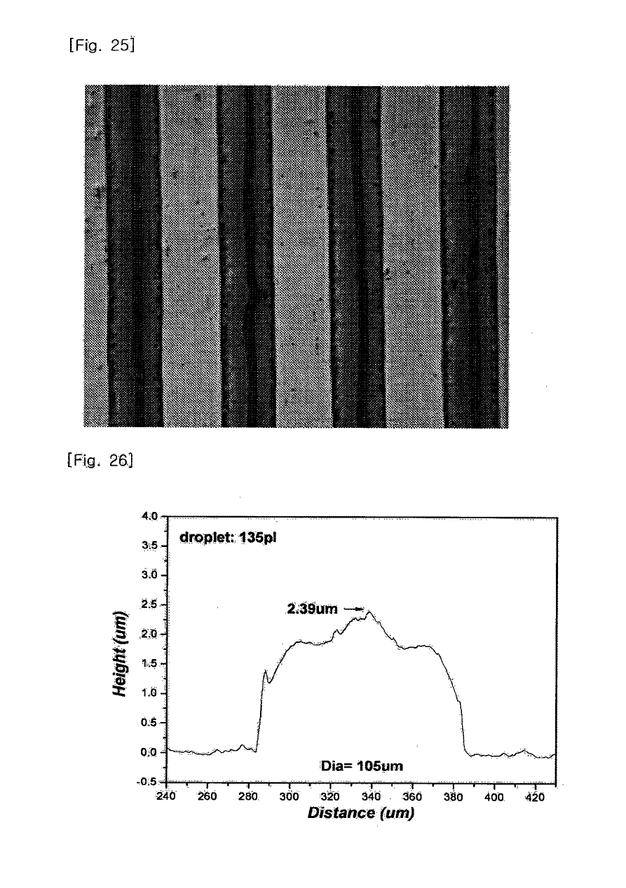

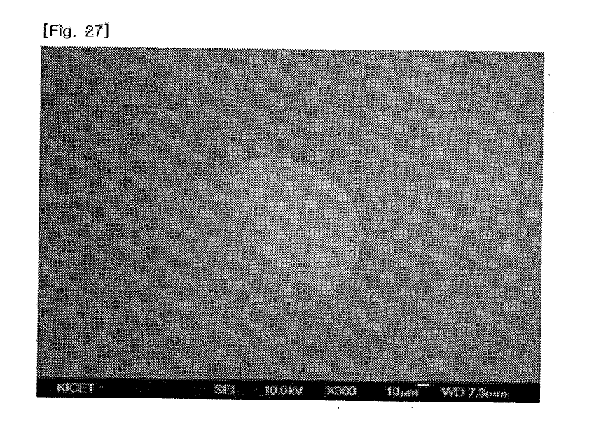

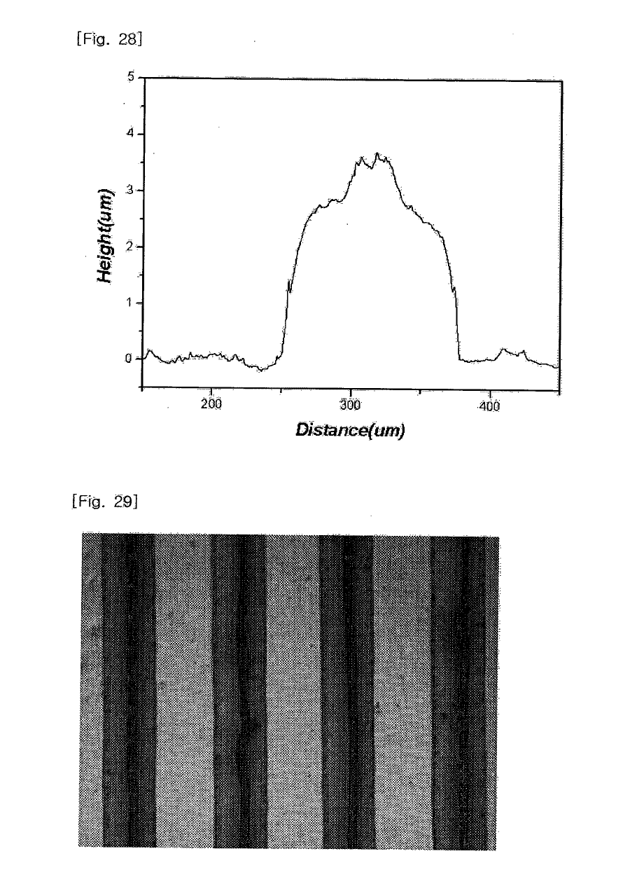

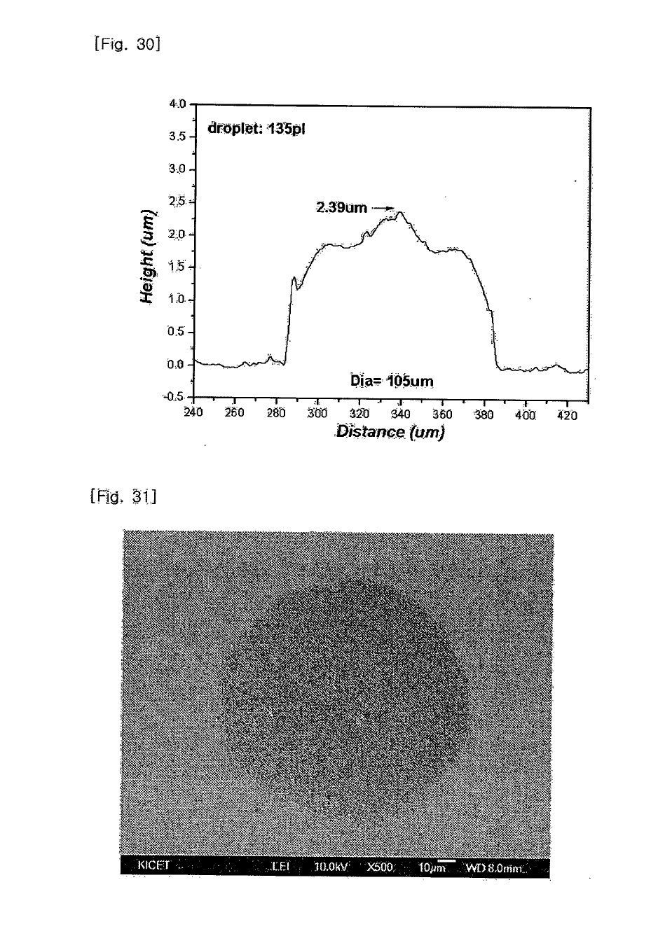

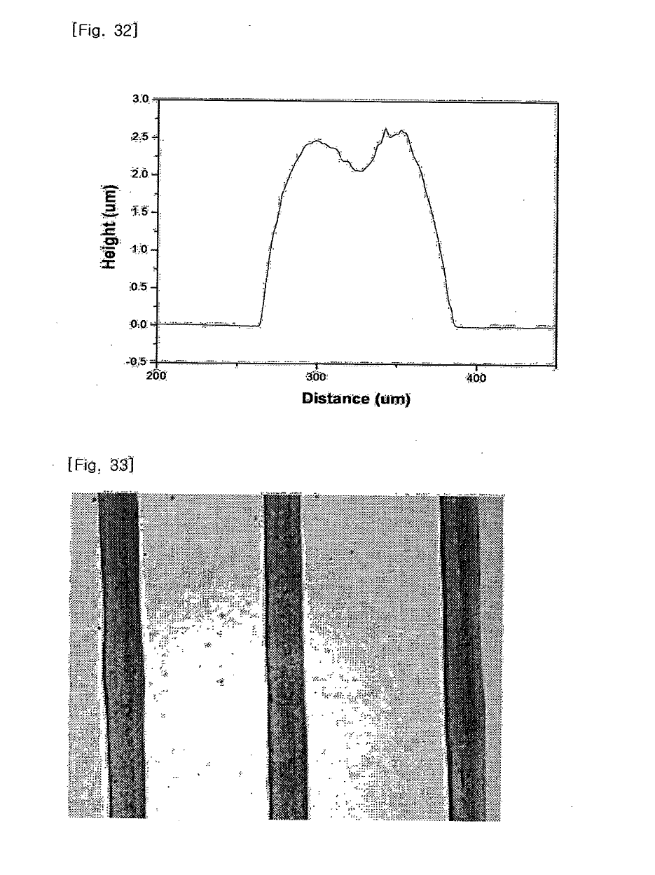

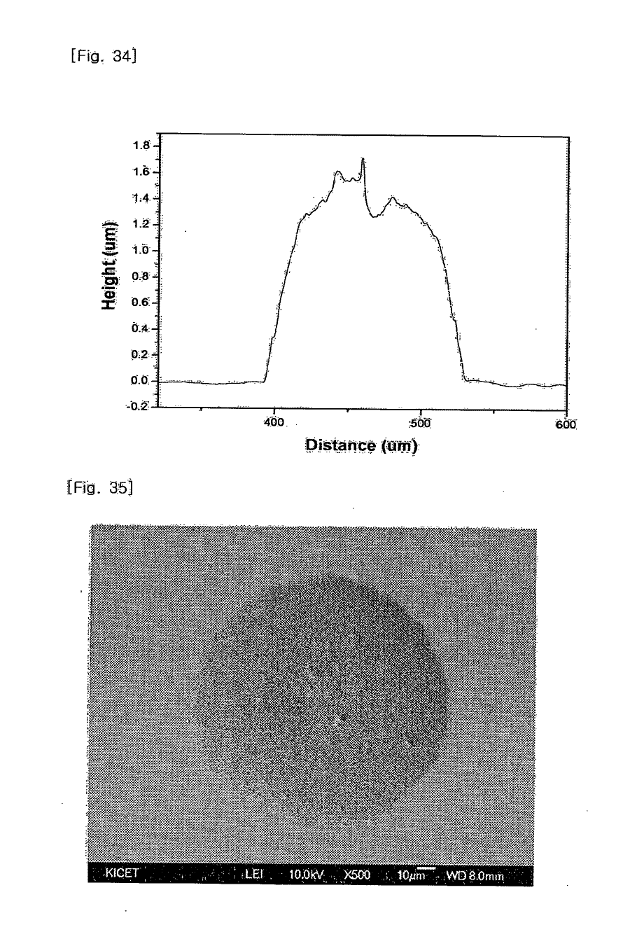

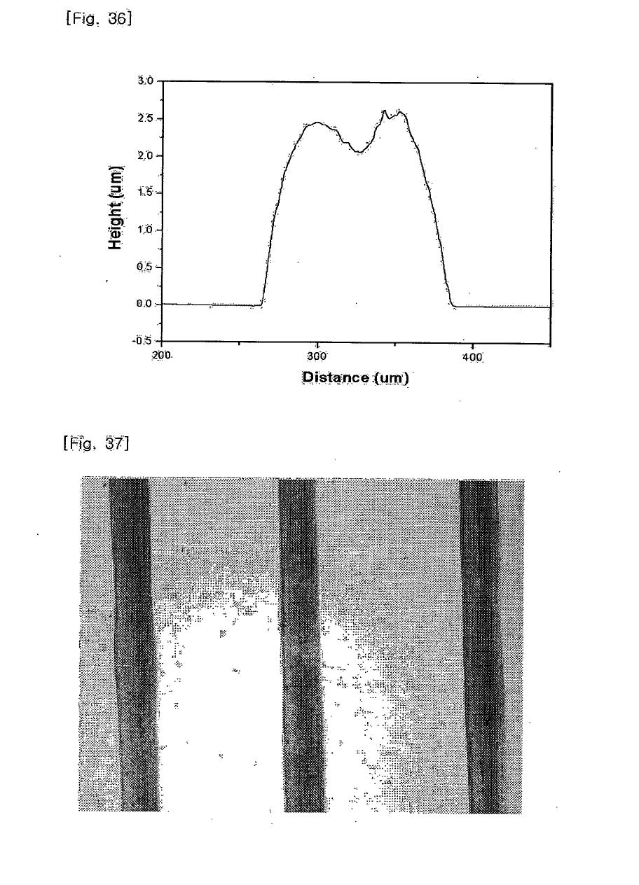

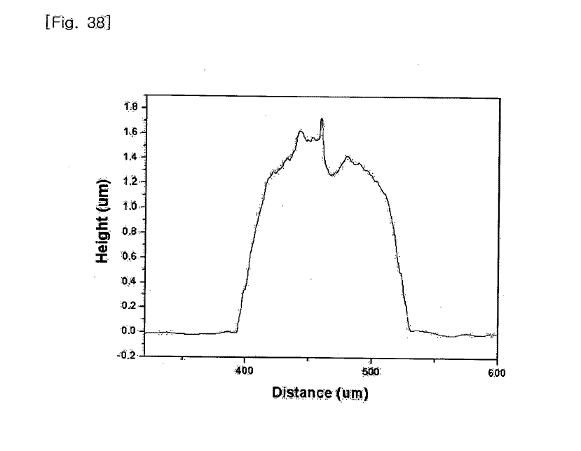

FIGS. 23 to 26 show dot and line pattern alumina ceramic films formed using Mixture Solvent 1, and FIGS. 27 to 30 show dot and line pattern barium titanate ceramic films formed Mixture Solvent 1. Specifically, FIGS. 23 and 27 are electron micrographs of the dot patterns, FIGS. 24 and 28 are graphs of surface roughness of the dot patterns, FIGS. 25 and 29 are CCD images of the line patterns, and FIGS. 26 and 30 are graphs of surface roughness of the line patterns. Further, FIGS. 31 to 34 show dot and line pattern alumina ceramic films formed using Mixture Solvent 2, and FIGS. 35 to 38 show dot and line pattern barium titanate ceramic films formed using Mixture Solvent 2. Specifically, FIGS. 31 and 35 are electron micrographs of the dot patterns, FIGS. 32 and 36 are graphs of surface roughness of the dot patterns, FIGS. 33 and 37 are CCD images of the line patterns, and FIGS. 34 and 38 are graphs of surface roughness of the line patterns.

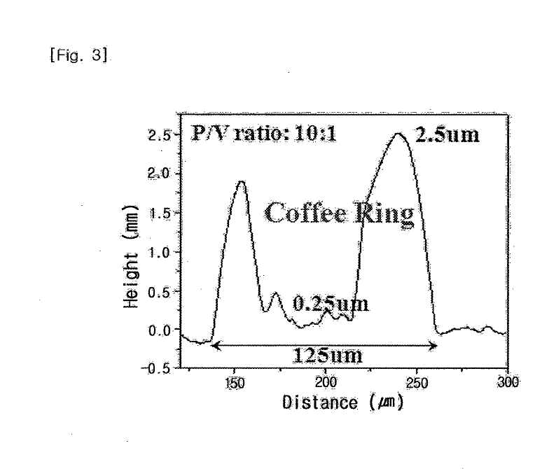

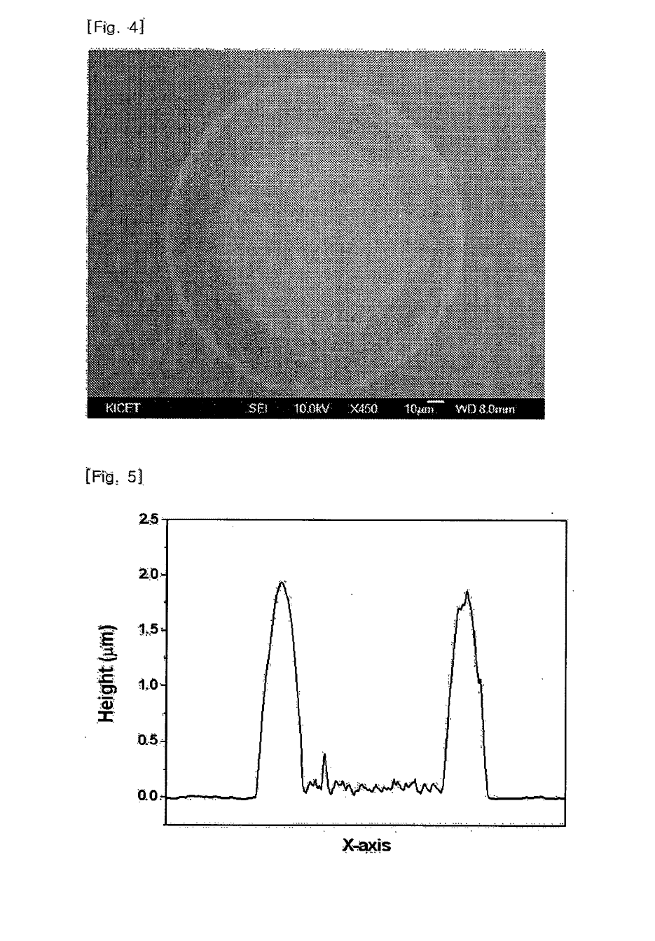

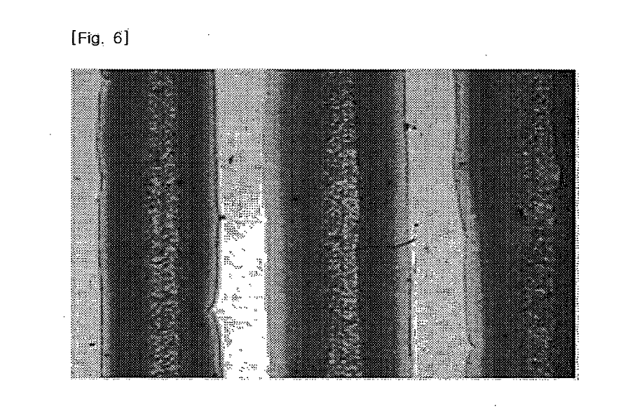

Referring to FIGS. 23 to 38, when the ceramic ink containing the ceramic powder and Mixture solvent 1 or 2 was used for inkjet printing, the coffee ring pattern as shown in FIGS. 2 to 7 was not formed. Further, the graph of surface roughness became a regular distribution curve of a “Gaussian distribution” instead of the ‘rabbit ear” distribution, and the ratio of peak to valley was less than 1.5. Therefore, it can be seen that uniform filling of the ceramic powder was achieved.

Although some exemplary embodiments have been described, it will be apparent to a person having ordinary knowledge in the art that there can be an allowable tolerance in the features of these embodiments depending on the average particle size, distribution and optical properties of the composition powder, purity of raw materials, and added amounts of impurities. Further, it should be understood that these embodiments are provided for illustration only, and that various modifications, changes and additions can be made by a person having ordinary knowledge in the art without departing from the scope and spirit of the invention and should be construed as being included in the scope of the claims and equivalents thereof.

1. A ceramic ink comprising a solvent having a ceramic powder dispersed therein and being printed on a substrate by inkjet printing to form a thick ceramic film, wherein Dᵥ and Dₕ of particles of the ceramic powder averagely satisfy the following Equation 1, and, assuming that a plurality of interior angles are defined along a periphery of a cross-section of each of the particles, the maximum interior angle is less than 135 degrees.
$$\frac{\vert {D}_{h} - {D}_{v} \vert}{{D}_{h}} < 20 \% , \qquad Equation 1$$
wherein Dᵥ and Dₕ indicate the maximum vertical length and the maximum horizontal length of the cross-section of each of the particles, respectively.

2. The ceramic ink of claim 1, wherein the ceramic powder has a multi-modal size distribution.

3. The ceramic ink of claim 2, wherein the multi-modal size distribution is in the range of 20 nm˜1 μm.

4. A ceramic ink comprising a solvent having a ceramic powder dispersed therein and being printed on a substrate by inkjet printing to form a thick alumina ceramic film, wherein the solvent comprises at least one mixture selected from the group consisting of a mixture of ethylene glycol monomethyl ether and dipropylene glycol monomethyl ether, a mixture of N,N-dimethylformamide and formamide, a mixture of acetonitrile and butanol, a mixture of nitromethane and butanol, and a mixture of water and N,N-dimethylformamide.

5. A ceramic ink comprising a solvent having a ceramic powder dispersed therein and being printed on a substrate by inkjet printing to form a thick alumina ceramic film, wherein the solvent comprises at least one selected from the group consisting of: a composition of (100−x) vol % of ethylene glycol monomethyl ether+x vol % of dipropylene glycol monomethyl ether; a composition of (100−x) vol % of N,N-dimethylformamide+x vol % of formamide; a composition of (100−x) vol % of acetonitrile+x vol % of butanol; a composition of (100−x) vol % of nitromethane+x vol % of butanol; and a composition of (100−x) vol % water+x vol % of N,N-dimethylformamide, where x is in the range of 0<x≦25.

6. The ceramic ink of claim 5, wherein x is in the range of 5≦x≦25.

7. The ceramic ink of claim 4 or 5, wherein the ceramic powder is contained in an amount of 1 vol %˜12 vol % with respect to a total amount of the ceramic ink.
